(19) United States
(12) Patent Application Publication
(10) Pub. No.: US 2019/0236268 A1
(43) Pub. Date: Aug. 1, 2019

(54) BEHAVIOR DETERMINING METHOD, BEHAVIOR DETERMINING APPARATUS, AND NON-TRANSITORY COMPUTER READABLE MEDIUM

(71) Applicant: Preferred Networks, Inc., Chiyoda-ku (JP)

(72) Inventors: Ren KIMURA, Chiyoda-ku (JP); Hirochika ASAI, Chiyoda-ku (JP); Yusuke DOI, Chiyoda-ku (JP)

(73) Assignee: Preferred Networks, Inc., Chiyoda-ku (JP)

(21) Appl. No.: 16/262,804

(22) Filed: Jan. 30, 2019

(30) Foreign Application Priority Data
Jan. 31, 2018 (JP) 2018-015901

(51) Int. Cl. G06F 21/53; G06F 21/56; G06N 20/00; G06F 12/0802

(52) U.S. Cl. CPC G06F 21/53; G06F 21/566; G06F 2212/657; G06F 12/0802; G06F 2221/033; G06N 20/00

(57) ABSTRACT

A behavior determining method includes causing a program to operate on a virtual environment including a virtual memory, while the program is operating on the virtual environment, generating access information of the virtual memory for determining a behavior of the program, based on information of at least one of a first flag or a second flag, the first flag indicating whether or not the program has read from a location in a virtual address space, and the second flag indicating whether or not the program has written to the location in the virtual address space, and inferring whether the behavior of the program is normal or abnormal, based on the access information.

### CROSS-REFERENCE TO RELATED APPLICATIONS

This application claims the benefit of and priority to Japanese Patent Application No. 2018-015901, filed on Jan. 31, 2018, the entire contents of which are incorporated herein by reference.

### FIELD

Embodiments described herein relate to a behavior determining method, a behavior determining apparatus, and a non-transitory computer readable medium.

### BACKGROUND

Studies have been made on a method which executes a program on a simulator or an emulator and through machine learning, determines a behavior which is being executed, in order to determine whether the behavior of the program is normal or whether an abnormal routine inserted by a malware. However, when executed in the simulator or the like, some malware detects that the program is being executed in the simulator or the like and stops a behavior as malware, which may make it difficult to detect an abnormal behavior.

Some other method uses memory accesses in order to detect a program whose behavior is not legitimate. For example, this method obtains all the memory accesses to create a histogram and determines the behavior, but this method puts a computer under a large load.

### BRIEF DESCRIPTION OF THE DRAWINGS

FIG. 1 illustrates functions of a behavior determining apparatus according to a first embodiment.

FIG. 2 illustrates an example of the hardware configuration of the behavior determining apparatus according to the first embodiment.

FIG. 3 and FIG. 4 illustrate flows of learning processing according to the embodiment.

FIG. 5A and FIG. 5B illustrate examples of access information.

FIG. 6 illustrates functions of a behavior determining apparatus according to a second embodiment.

FIG. 7 illustrates an example of the inference of access information.

### DETAILED DESCRIPTION

According to some embodiments, a behavior determining method may include causing a program which is to be inspected to operate on a virtual environment including a virtual memory and virtual processing circuitry, while the program is operating on the virtual environment, generating access information of the virtual memory for discriminating or determining a behavior of the program, based on information of at least one of a first flag or a second flag, the first flag indicating whether or not the program has read from addresses in a virtual address space, and the second flag indicating whether or not the program has written to the addresses in the virtual address space, and inferring whether the behavior of the program is normal or abnormal, based on the access information.

### First Embodiment

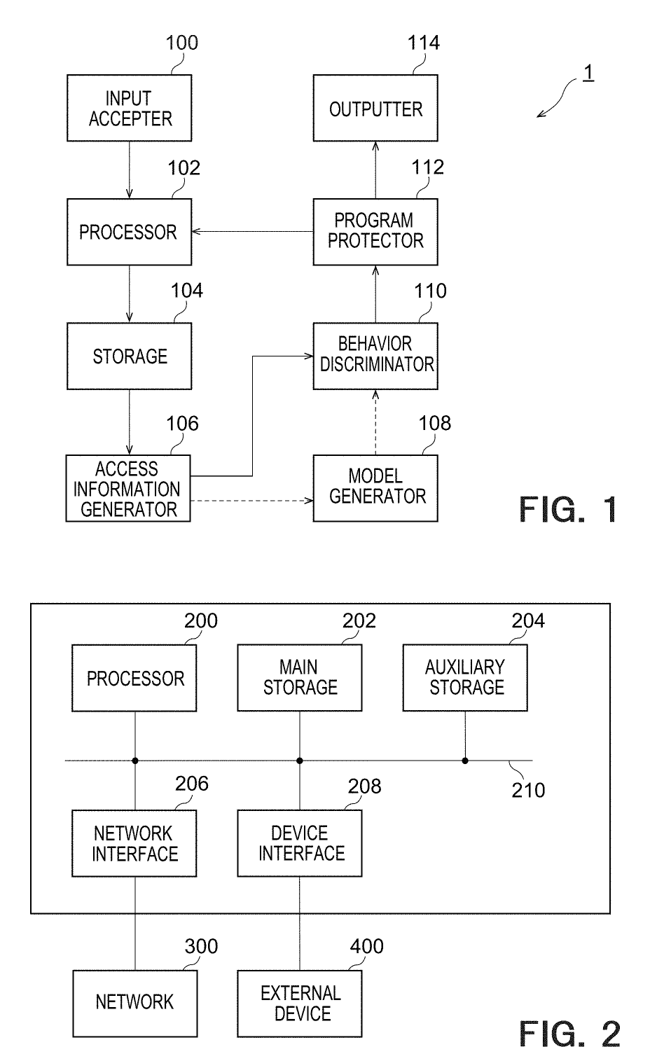

FIG. 1 is a block diagram illustrating functions of a behavior determining apparatus according to the first embodiment. The behavior determining apparatus 1 may include an input accepter 100, a processor 102, a storage 104, an access information generator 106, a model generator 108, a behavior discriminator 110, a program protector 112, and an outputter (or an output device) 114. The behavior determining apparatus 1 may cause an inspection target program (which is a program to be inspected) to operate on a virtual environment, thereby determining a behavior of the inspection target program.

The input accepter 100 may be an interface which accepts the input of the inspection target program. Further, the input accepter 100 may include a user interface (UI), for example, hardware such as a keyboard and a mouse, which accepts instructions and so on from a user of the program, a manager who inspects the program, or the like, and a graphical user interface (GUI) for input which is displayed on a display. When the inspection target program is input, the input accepter 100 may output the inspection target program to the processor 102.

The processor 102 may cause the inspection target program to operate on the virtual environment (e.g., VMM: Virtual Machine Manager) including a virtual memory and virtual processing circuitry. The processor 102 may include, for example, a CPU (Central Processing Unit) and may control various operations to execute processing. Alternatively, the processor 102 may be implemented by a program executed on the CPU. The processor 102 may cause the inspection target program to operate, and may store information on which place (or location) on a virtual address space in the storage 104 the inspection target program has accessed or written in timing with, for example, a clock of the CPU.

The storage 104 may include a volatile or nonvolatile storage and store various data. For example, the storage 104 may include a volatile primary storage such as a RAM (Random Access Memory), and store page tables showing a mapping state of the virtual address space and a physical address space in a case where the inspection target program is operating on the virtual environment configured in the processor 102.

The access information generator 106 may obtain a memory state stored in the storage 104 to generate access information which is information about a memory access state for the inspection. For example, the access information generator 106 may obtain the page tables stored in the storage 104 at predetermined time intervals, extract data stored in the page tables, and apply conversion and so on to the extracted data, thereby generating the access information used for the inspection.

More specifically, the following flags which are stored in each of the page tables may be obtained: a first flag indicating whether or not an access (a read, or a read and/or a write) has been made to a predetermined address range (e.g., page) in the virtual address space, and a second flag indicating whether or not a write has been made to a certain address range. Thus, the access information may be generated based on not only whether or not an access has been made but also whether or not a write has been made.

For example, a MMU (Memory Management Unit) mounted on the CPU may rewrite these pieces of flag information based on the access state. The access information generator 106 may generate the access information by referring to the page tables rewritten by the MMU. In this manner, the access information of a memory area may be obtained on a page-by-page basis, for example, in 4 KiB units.

The access information generator 106 may be implemented by a program provided on the CPU provided in the processor 102. The access information generator 106 may output the obtained access information to the model generator 108 or the behavior discriminator 110.

Based on the access information generated by the access information generator 106, the model generator 108 may generate, through learning, a behavior discrimination model (or a behavior determination model) for discriminating (or determining) whether the program on the VMM is normal or abnormal. The generated behavior discrimination model may be output to the behavior discriminator 110. In some embodiments, the model generator 108 is not provided in the behavior determining apparatus 1, but the model may be generated by an external model generator to be obtained by the behavior discriminator 110.

Based on the access information generated by the access information generator 106, the behavior discriminator 110 may analyze a pattern with which the inspection target program operating on the virtual environment accesses to the virtual address space, and perform the clustering of the behavior of the inspection target program. That is, probabilities with which the behavior of the inspection target program belongs to a normal class and an abnormal class may be calculated, whereby the behavior of the inspection target program is discriminated. The behavior discriminator 110 may be configured to have, in advance, a behavior discrimination model generated by the model generator 108, and discriminate the behavior by inputting the time-series access information generated by the access information generator 106 to the behavior discrimination model.

The program protector 112 may obtain information about the behavior discriminated by the behavior discriminator 110, infer whether the behavior of the inspection target program is normal or abnormal, and when necessary, cause a warning (or an indication) to be issued or cause the operation of the program to be stopped, thereby protecting the program. When the program is inferred as abnormal, the warning may be displayed to the user through the outputter (or output device) 114, or an instruction to stop the operation of the program on the virtual environment may be output to the processor 102.

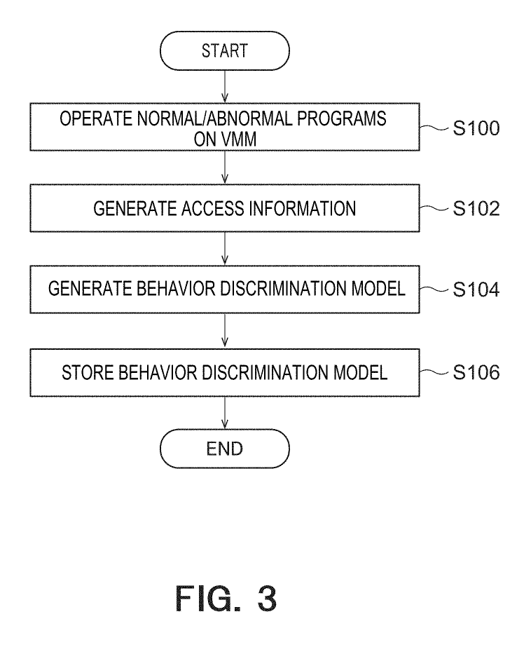

The outputter 114 may output the result of the inference which the program protector 112 has made regarding the behavior of the inspection target program. The outputter 114 may include, for example, a display, and output the result of the inference regarding the behavior of the inspection target program to the user through the display. As another example, the outputter 114 may include a different device such as a speaker which outputs the result by means of sound, a vibrator which notifies the result by means of vibration, an indicator which notifies the result by means of light, or a printer which prints out the result. The display, if used, may be the same as the aforesaid display which displays the GUI of the input accepter 100. Next, an example of the hardware configuration will be described. FIG. 2 is a diagram illustrating an example of the hardware configuration of the behavior determining apparatus 1 according to the first embodiment.

As illustrated in FIG. 2, the behavior determining apparatus 1 may include a processor 200, a main storage 202, an auxiliary storage 204, a network interface 206, and a device interface 208. These modules may be mutually connected via a bus 210.

The processor 200 may include a CPU. The CPU may be the processor 102, and on the CPU, the access information generator 106, the behavior discriminator 110, and the program protector 112 may be implemented by a program. The virtual environment may be configured on this CPU. Then, on the virtual environment configured on the CPU, the inspection target program may be executed.

The processor 200 may include a processor functioning as an accelerator such as a GPU (Graphics Processing Unit) besides the CPU. In some embodiments, high-cost processing such as the generation of the model through learning may be processed in parallel on the accelerator.

The main storage 202 may include a ROM (Read Only Memory). In the ROM, a program which executes an OS (Operating System) for activating the behavior determining apparatus 1 and the aforesaid program implementing the modules (e.g., the access information generator 106, the behavior discriminator 110, the program protector 112) may be stored. The processor 200 may execute the operation of the behavior determining apparatus 1 according to the program stored in the main storage 202.

The auxiliary storage 204 may include RAM. The auxiliary storage 204 may be used as at least part of the storage 104. The virtual address space of the virtual environment of the processor 200 may be stored in the RAM of the auxiliary storage 204. In this case, the page tables which map the virtual addresses and physical addresses may also be stored in the RAM of the auxiliary storage 204.

The network interface 206 connects to an external network 300, and various data, control commands, and so on are input and output thereto/therefrom. The device interface 208 connects to an external device 400, and data, control commands, and so on from the external device 400 are input and output thereto/therefrom.

At least one of the input accepter 100 and the outputter 114 may be connected through the network interface 206 or the device interface 208. For example, the display mentioned above as an example of the input accepter 100 and the outputter 114 may be the external device 400 connected through the device interface 208. As another example, the external device 400 may be one connected to the network interface 206 through the network 300.

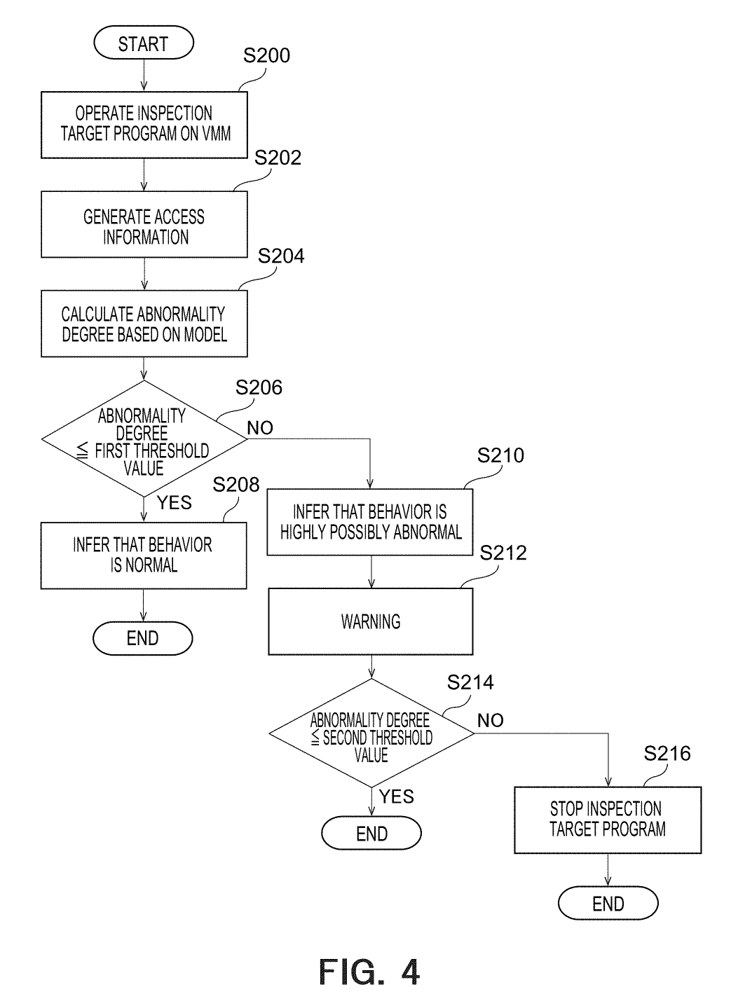

Next, the operation of the behavior determining apparatus 1 according to the first embodiment will be described. FIG. 3 is a flowchart illustrating a flow of processing for generating the model used for the discrimination processing in the behavior discriminator 110 of the behavior determining apparatus 1. In the processing for generating the model, data may be processed as indicated by the broken line in FIG. 1.

First, normally operating programs and abnormally operating programs may be input through the input accepter 100, and the programs may be made to operate on the VMM in the processor 102 (S100).

Next, regarding each of the programs operating on the VMM, the access information generator 106 may generate the access information from memory use information which contains access information and so on in the virtual address space on the storage 104 (S102). In a case where processes run on a computer, the used memory may be managed using address spaces (e.g., virtual address spaces) for process. In some embodiments, each address space is independently provided for a corresponding process. Management information such as the mappings between virtual address and physical address each may be stored in the page tables.

In a case where the OS causes the programs to operate, the normally operating programs and the abnormally operating programs tend to access different addresses in the virtual address space. For example, the abnormally operating programs may behave so as not to allow another process to access a specific directory, or behave so as to access a system area which the normally operating programs would not access.

Therefore, when the programs activate and operate on the VMM, the access information generator 106 may generate the access information indicating to which place on the virtual address an access or a write has been made.

Specifically, data of the first flags stored in the page tables may be first obtained, thereby finding which pages the programs have accessed. Subsequently, an access state to each page may be converted into a tensor suitable for learning, for example, into a vector. In this process, in some embodiments, the access states regarding all the pages do not necessarily have to be obtained, and for example, data may be shrunk by deleting a useless address or combining a plurality of addresses.

As an example, the access information generator 106 may obtain the aforesaid data of the first flags as vectors every predetermined time, for example, every 100 milliseconds and combine the data during a predetermined period, for example, two seconds into one piece of access information, that is, the access information generator 106 may generate, as the access information, data containing time-series information. As the access information generated by the access information generator 106, the access information of the normally operating programs and the access information of the abnormally operating programs may both be obtained, or only the access information of the normally operating programs may be obtained. The aforesaid numerical values of the predetermined time and the predetermined period are just described as examples, and they can be any numerical values.

Further, the data to be obtained may be the data of the second flags instead of the first flags, or may be the data of both the first flags and the second flags. The access information generator 106 may label the obtained access information as the normally operating program or the abnormally operating program, and store the access information as training data.

In a case where both of the data are used, the information of the first flags and the information of the second flags may be generated as data of different channels, or by mixing the information of the first flags and the information of the second flags by a linear or nonlinear function, the mixture may be generated as data of one channel. Further, both of the data may be combined into data of one channel, and the combination may be generated as a vector in which the number of elements is twice the number of pages of interest.

The access information may be stored in a storage in the behavior determining apparatus 1, or may be stored in an external file server or the like through the network interface 206.

Regarding the various normally operating programs and/or abnormally operating programs, the access information generator 106 may obtain the pieces of access information when they are activated and operated on the VMM. The plurality of pieces of access information thus generated may serve as the training data.

After the access information is obtained and vectorized, the first flags or the second flags may be cleared. For example, clearing the first flags makes it possible to detect accesses that the programs make during a period until the next access information is obtained. An alternative way may be not to clear the flags until they are cleared by the CPU or the like.

Next, the model generator 108 may perform learning using, as the training data, the access information generated by the access information generator 106, to generate the behavior discrimination model (S104).

For example, a model which receives a predetermined number of time-series data of address information generated by the access information generator 106 and discriminates whether the input address state indicates a normal behavior or an abnormal behavior may be generated as a deep-learning classifier which uses a convolutional neural network. In some embodiments, the model, as a classifier, may be a model which outputs the discrimination between a normal class or an abnormal class. In some embodiments, the model may be a model which outputs a probability with which the program belongs to the normal class or the abnormal class.

For generating the model, the model generator 108 may use a machine learning method such as Random Forest or SVM (Support Vector Machine), or may use neural network models. Further, a method such as mini-batch may be appropriately used according to the number of the training data.

Next, the model generator 108 may output the generated model to the behavior discriminator 110, and the behavior discriminator 110 may store the model therein (S106). In some embodiments, the model may be stored in a place different from the behavior discriminator 110 such that the behavior discriminator 110 can use the model when necessary.

In this manner, the model used for discriminating the behavior may be generated through learning. Whether the behavior of the inspection target program is normal or abnormal may be inferred using this model. FIG. 4 is a flowchart illustrating a flow of inference processing.

First, the processor 102 may activate the inspection target program on the VMM to cause the inspection target program to operate on the VMM (S200). Subsequently, access information while the inspection target program is operating may be generated (S202). The processes at S200 and S202 may be the same as those at S100 and S102 in FIG. 3 described above.

Next, the access information of the inspection target program generated by the access information generator 106 may be input to the model generated by the model generator 108, and from the output result of the model, an abnormality degree which is a degree to which the behavior of the inspection target program is abnormal may be calculated (S204). The number of elements, structure, and so on of the data which is input to the model at this time may be the same as those of the input data used when the model generator 108 generates the model. In the first embodiment, the behavior discriminator 110 may calculate the abnormality degree of the inspection target program using the behavior discrimination model which is the classifier, for instance.

As described above, this classifier may be a classifier which distinctly discriminates whether the behavior belongs to the normal class or belongs to the abnormal class, or may be a classifier which outputs the probability indicating to what degree it belongs to the normal class or to what degree it belongs to the abnormal class.

In the case where the model is the classifier of the distinct classification type, the behavior discriminator 110 may calculate the abnormality probability as 0% in a case where the behavior belongs to the normal class, and calculate the abnormality probability as 100% in a case where the behavior belongs to the abnormal class, and output the abnormality probability as the abnormality degree. As another example, in the case where the model is the classifier which outputs the probability with which the behavior belongs to the normal class and the probability with which the behavior belongs to the abnormal class, the behavior discriminator 110 may output the probability with which the behavior belongs to the abnormal class as the abnormality degree, or may calculate the abnormality degree by predetermined conversion of the probabilities with which the behavior belongs to the normal class and the abnormal class, and output the calculated abnormality degree.

Furthermore, the normal class and the abnormal class each may be divided into internal states. Such division and probability calculation may be performed based on the labels of the training data used in the phase where the model generator 108 generates the model. In such a case, the sum of the abnormality probabilities may be output, or vectors of the probabilities of the respective classes may be output.

In the discrimination using the model, the pieces of time-series access information, which is made into a batch every predetermined time, may be used. In this case, based on the plurality of abnormality probabilities obtained from the plurality of pieces of access information, the abnormality degree for each batch of the pieces of access information may be calculated.

Next, the program protector 112 may compare the abnormality degree of the inspection target program calculated by the behavior discriminator 110 with a first threshold value, to determine whether the behavior of the inspection target program is normal or abnormal (S206). The abnormality degree may be represented by an index such as, for example, 0 in a case where the behavior is determined as completely normal, and 1 in a case where it is determined as completely abnormal. The first threshold value may be a value calculated through learning, an empirical value, or a value which is varied according to desired accuracy of the abnormality detection. For example, in a case where the behavior is determined as abnormal when the program does not operate normally in a strict sense, the first threshold value may be 0.

However, since a learning model is used, the normality and abnormality determination with a 100% probability is not likely possible. Therefore, a validation test may be conducted by inputting, to the model, normally behaving programs and abnormally behaving programs which are not used for the learning when the model is generated in the learning phase illustrated in FIG. 3, and based on a probability with which correct answers are obtained in the test, the first threshold value may be set. In this case, the model generator 108 may output in advance the test result to the program protector 112. In some embodiments, the first threshold value does not necessarily have to be set in the above-described manner, and may be one enabling to properly discriminate whether the output of the model indicates a behavior highly possibly normal or a behavior highly possibly abnormal.

In a case where the abnormality degree is equal to or less than the first threshold value (S206: YES), the program protector 112 may infer that the inspection target program is a normal program (S208), and the processing may be ended. At this timing, a notification that the inspection target program is a normal program may be output through the outputter 114. The inspection may be further continued instead of the momentary determination. A routine in this case may be to return to S202 after S208.

On the other hand, in a case where the abnormality degree is larger than the first threshold value (S206: NO), the program protector 112 may infer that the behavior of the inspection target program is highly possibly an abnormal behavior (S210). As in the case where the behavior is inferred as normal, the processing may go to S202 after S210 to continue the monitoring of the inspection target program.

As another example, in the case where the plurality of time-series abnormality degrees are calculated from the batches of the pieces of access information, based on the calculated abnormality degrees, it may be determined whether the behaviors obtained from the respective pieces of access information are abnormal or normal, and based on the time-series determination results, the subsequent operation of the program protector 112 may be decided. For example, if the determination results of 50 steps indicate abnormality in a case where the determination results in 100 steps are obtained, the behavior of the inspection target program itself may be determined as abnormal. In this case, a warning (or an indication) may be issued, and if the determination results of 75 steps still indicate abnormality, the operation of the inspection target program may be stopped.

The following processes from S212 to S216 may be optional, and some different processes may be performed based on that the inspection target program is a program exhibiting an abnormal behavior.

For example, after inferring that the inspection target program is a program exhibiting an abnormal behavior, the program protector 112 may issue, through the outputter 114, a warning (or an indication) to the effect that the behavior of the inspection target program is highly possibly abnormal (S212).

Further, a risk degree may be determined by comparing the abnormality degree with a second threshold value which is larger than the first threshold value (S214). For example, an abnormality degree indicating a risk degree at which the operation of the inspection target program should be immediately stopped may be set in advance, and a value of this abnormality degree may be set as the second threshold value.

In a case where the abnormality degree is equal to or less than the second threshold value (S214: YES), the processing may be ended, or the monitoring of the behavior of the inspection target program may be continued. Further, since the program highly possibly has an abnormal behavior, its access information may be stored as access information of a program exhibiting an abnormal behavior, for future use as training data, or the behavior discrimination model may be updated by performing intensive learning or the aforesaid learning in parallel with the monitoring.

On the other hand, in a case where the abnormality degree is larger than the second threshold value (S214: NO), the program protector 112 may output a control command to the processor 102 to stop the processing of the inspection target program (S216). In the case where the processing of the inspection target program is stopped, the program may be stopped without the warning being issued, that is, without going through S212.

It is also possible to thereafter resume the stopped operation of the inspection target program by the user operating the VMM. Alternatively, the operation of the inspection target program may be restarted in a state where a safe state is confirmed in advance.

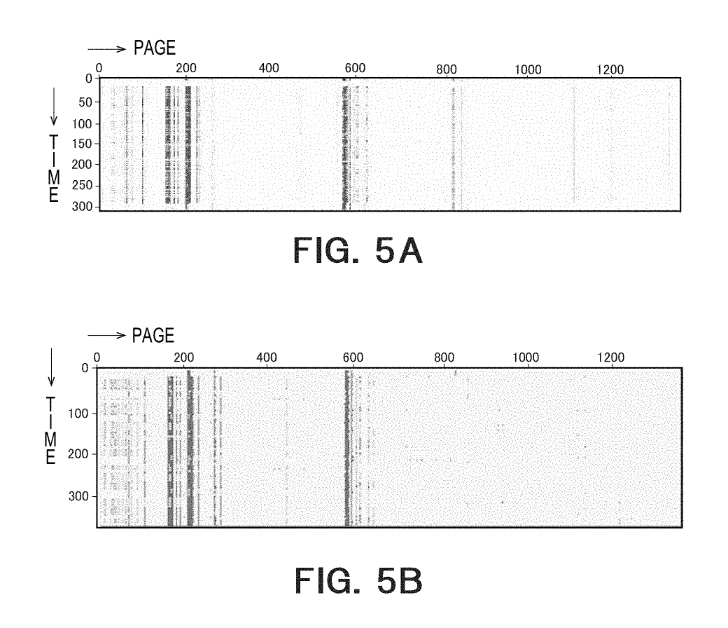

FIG. 5A and FIG. 5B are charts illustrating examples of the generated access information. These drawings illustrate sets of pieces of time-series access information, with the horizontal axis representing page index and the vertical axis representing time. As an example, these sets of the access information are generated by obtaining the first flags, and upon obtaining the first flags, the first flags are cleared. In the drawings, the number N of pages is about 1350, data are shrunk to N pages, and pieces of the access information in one horizontal row indicate access states of the pages at the same timing.

A page colored black at a certain time is a page accessed during a period from a previous reset time up to the certain time, and a page colored at a certain time white is a page not accessed during a period from a previous reset time to the certain time. The accessed page is, for example, a page whose first flag has 1, and a not-accessed page is a page whose first flag has 0. In some embodiments, what 0 and 1 of the flag mean can be the other way round, e.g., the accessed page may be a page whose first flag has 0, and a not-accessed page is a page whose first flag has 1.

FIG. 5A is an example illustrating page access states by a program whose behavior is normal, and FIG. 5B is an example illustrating page access states by a program whose behavior is abnormal.

The access information may be information about a state of the pages at a given time, that is, may be information in one horizontal row (the number of elements N) in these drawings, or may be information in which page states during a predetermined period T are combined, that is, in which pieces of information in a predetermined number of horizontal rows (the number of elements N×T) are combined. In the case where the pieces of information in the predetermined number of rows are combined, the access information may be obtained as a one-dimensional vector, or may be obtained as a two-dimensional matrix, that is, as a matrix having elements whose number equals the number of pages×the predetermined period. Based on the obtained access information, the aforesaid processing for generating the model and discriminating the behavior is performed.

The procedure of the inference based on the model may be, for example, to further obtain access information when a predetermined time passes after the access information having the N×T elements is obtained, combine the input data into a batch using the plurality of pieces of access information thus obtained, followed by the inference.

The behavior discrimination model used by the behavior discriminator 110 in the first embodiment may be a model which, when access information which is part or all of the information illustrated in FIG. 5A is input thereto, outputs a high normality probability and a low abnormality probability. On the other hand, when access information which is part or all of the information illustrated in FIG. 5B is input thereto, the model may output a low normality probability and a high abnormality probability.

As described above, according to the first embodiment, by causing the inspection target program to operate on the virtual environment and obtaining, as the access information, the state of the virtual address space in the virtual environment, it is possible to reduce the overhead required to infer whether the inspection target program is a normally operating program or an abnormally operating program, based on the memory access information of the inspection target program.

By reading the memory state in the virtual environment, it is possible to monitor a behavior of even malware which detects an emulator or the like or malware which detects a sandbox or the like. Further, using information on a memory read/write state in the virtual address space, there is no need to activate a debugger or perform an analysis by function hooking or the like, that is, there is no need to perform an extra operation, making it possible to discriminate the behavior of the program at a low cost and with a less overhead.

In the above, the access information serving as the learning data and the access information of the inspection target program may be obtained during the operation, but this is not restrictive. In some embodiments, the access information may be obtained before the operation of each program is started after it is activated from a pre-activation state. By thus obtaining the access information before the program operates, the access information at the program activation timing may be obtained.

For example, if the aforesaid CPU is one manufactured by Intel, it is capable of discriminating the behavior using the function of the MMU, based on information which is obtained using a hardware function, and can be implemented with a high speed and a low power consumption. Further, there is also an advantage that, since the inspection target program does not operate in the emulator or the like, the program is not easily detected by malware or the like.

### Second Embodiment

The above-described first embodiment uses the discrimination model which discriminates whether the behavior of the program is normal or abnormal, but the second embodiment can determine a behavior of an inspection target program by using, instead of the discrimination model, an access information inference model which, when access information in a normal behavior is input thereto, can infer and output the access information in the case of the normal behavior.

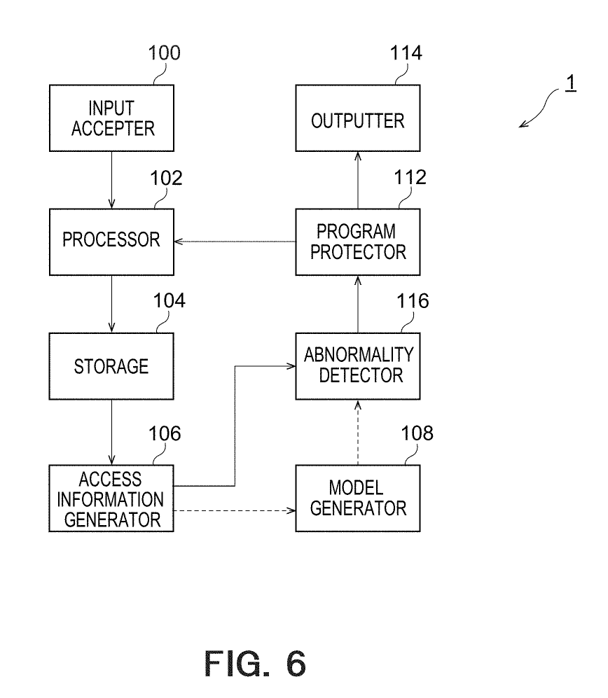

FIG. 6 is a block diagram illustrating functions of a behavior determining apparatus 1 in the second embodiment. The behavior determining apparatus 1 may include an abnormality detector 116 instead of the behavior discriminator 110 illustrated in FIG. 1. The abnormality detector 116 may be implemented with a special circuit (e.g., circuitry of a FPGA, CPU, GPU or other processing circuits implemented using electronic circuits), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like. Flows of processing for generating the model and processing for inferring the behavior may be the same as those in FIG. 3 and FIG. 4 respectively.

Referring back to FIG. 3, in the second embodiment, at S104, a model generator 108 may generate the access information inference model which, when pieces of time-series access information are input thereto, outputs next-timing access information or the pieces of time-series access information, instead of generating the behavior discrimination model functioning as the classifier. Specifically, the access information inference model which, when pieces of access information during a predetermined period are input thereto, outputs future access information may be generated as a neural network model.

For example, the model may be generated through supervised learning such that, for example, when pieces of access information in 100 unit times are input from an input layer, pieces of access information in an arbitrarily settable future time corresponding to 20 unit times may be output. In some embodiments, a model whose input and output elements are equal in number may be generated, or a model which receives pieces of access information in a plurality of unit times and outputs access information in one unit time after the next unit time may be generated.

In this training, in some embodiments, only the access information about programs exhibiting a normal behavior may be used as the training data, so that it is possible to reduce the cost for collecting data about programs exhibiting an abnormal behavior.

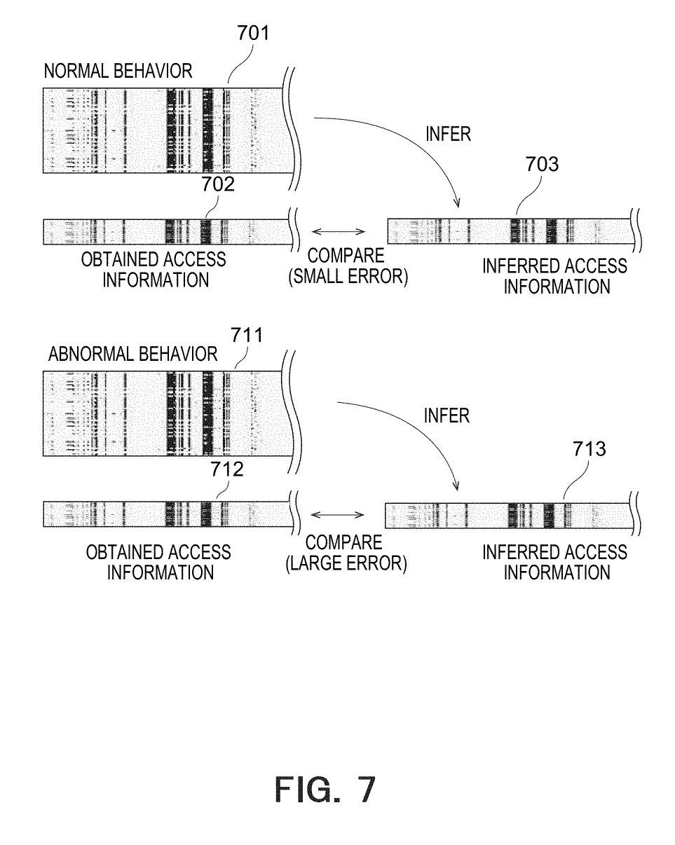

Referring back to FIG. 4, in the second embodiment, at S204 which is the phase for discriminating the behavior, the abnormality detector 116 (see FIG. 6) may input the access information generated by the access information generator 106 to the access information inference model generated by the model generator 108. FIG. 7 is a chart illustrating results obtained when the access information is input to the access information inference model. The model here may be a model which, for example, when pieces of access information in 100 unit times are input, infers and outputs pieces of access information in 20 unit times.

In the access information inference model generated as described above, when access information in a normal behavior state is input, the access information in the normal behavior state may be output. As illustrated in the upper drawing in FIG. 7, when access information 701 in the normal behavior is input, access information 703 having a small error from access information 702 which is actually obtained at a subsequent timing is output.

On the other hand, as illustrated in the lower drawing, in a case where access information 711 in an abnormal behavior is input, this access information inference model has not trained such an input, and therefore outputs access information 713 different from access information 712 which is actually obtained in the future, that is, outputs access information having a large error.

As described above, it is possible to produce a significant difference between the case where the access information in the normal behavior is input and the case where the access information in the abnormal behavior is input. This error may be output as NLL (Negative Log Likelihood). That is, the error may be calculated using, as an evaluation function, an equivalent one to a loss function used at the time of the model generation. In the case where the NLL is output, specific access information need not be output from the access information inference model, and only the NLL may be output. As another example, a correlation value or the like between the actual access information and the inferred access information may be output.

The abnormality detector 116 (see FIG. 6) may calculate the abnormality degree from the error thus obtained, that is, from the value of the NLL, the correlation value, or the like. However, in the case of the NLL, it may be output as the abnormality degree. In the case of the correlation value, its value may be higher as the behavior is more normal, and therefore, the abnormality degree may be calculated by taking a reciprocal or by normalizing it and then subtracting the normalized correlation value from 1.

In such a case, (1) the first threshold value according to which the program protector 112 determines whether or not the behavior is abnormal or normal based on the abnormality degree and (2) the second threshold value according to which the subsequent behavior of the program protector 112 is decided may be the same ones as those in the previously described first embodiment, or may be different values from those in the previously described first embodiment.

As described above, according to the second embodiment, it is also possible to discriminate whether the inspection target program is behaving normally or abnormally, using the access information of the virtual addresses.

### Modification Example of Second Embodiment

As another example, an autoencoder may generate an access information inference model which, when pieces of access information in a normal behavior in a predetermined number of unit times are input thereto, outputs the pieces of access information in the normal behavior in the predetermined number of unit times.

In some embodiments, the autoencoder may generate the access information inference model at S104 in FIG. 3, so that a feature of access information in a case of a normal behavior is automatically encoded in an intermediate layer having a smaller number of dimensions than the input layer. Consequently, when access information in a case of a normal behavior is input, it has this feature, and accordingly access information having a small error from the input can be output. On the other hand, in a case where access information in a case of an abnormal behavior is input, it may not have this feature, and accordingly, access information having a small error from the input may not be output.

Therefore, at S204 (see FIG. 4), the abnormality detector 116 may calculate the abnormality degree by comparing the access information which is input to the access information inference model and the inferred access information which is output from the model. In this modification example, similarly to the above-described second embodiment, specific inferred access information need not be output, and a value of the loss function used during learning, such as the NLL, may be calculated as the abnormality degree. The abnormality degree may be calculated by another method such as the mutual correlation as described above.

The first flag and the second flag in the above-described embodiments may be decided according to the specification of the processor, in particular, the CPU, in the behavior determining apparatus 1. For example, in a processor such as 64 or 1A-32 of Intel (registered trademark) Corporation, the first flag is defined as Accessed Flag, and the second flag is defined as Dirty Flag. In other CPU as well, those defined therein may be used.

Further, if the memory state cannot be directly dumped when the states of the first flag and the second flag are obtained, a state where the states of the CPU and the memory can be appropriately dumped may be produced, and thereafter the states of the virtual addresses may be obtained. For example, in a case where the memory state cannot be read from the outside, the memory state may be captured using snapshots, or the memory state may be captured by suspending the OS on the VMM. For example, by intentionally generating a page fault, the state of the first flag and/or the second flag may be obtained on a software basis by an interrupt handler.

As described above, even if a method of using the virtual address space differs depending on each CPU, it is possible to discriminate the behavior of the inspection target program in some embodiments as long as the method of using the virtual address is the same between a CPU used when the behavior discrimination model is generated and a CPU used when the behavior of the program is discriminated.

In the behavior determining apparatus 1 in each of the embodiments illustrated in FIG. 1 and FIG. 6, a controller may control all or some of the processor 102, the access information generator 106, the model generator 108, the behavior discriminator 110, and the program protector 112 collectively or separately. This controller may be a CPU, or an analog or digital control circuit, or may be a control circuit which is implemented by FPGA (Field Programmable Gate Array) or the like.

In the above-described entire description, at least a part of the devices or apparatus may be configured by hardware, or may be configured by software and a CPU and the like perform the operation based on information processing of the software. When it is configured by the software, a program which achieves above mentioned functions and at least a partial function thereof may be stored in a storage medium such as a flexible disk or a CD-ROM, and executed by making a computer read it. The storage medium is not limited to a detachable one such as a magnetic disk or an optical disk, but it may be a fixed-type storage medium such as a hard disk device or a memory. That is, the information processing by the software may be concretely implemented by using a hardware resource. Furthermore, the processing by the software may be implemented by the circuitry of a FPGA or the like and executed by the hardware. The generation of a learning model or processing after an input in the learning model may be performed by using, for example, an accelerator such as a GPU. Processing by the hardware and/or the software may be implemented by one or a plurality of processing circuitries representing CPU, GPU, and so on and executed by this processing circuitry. That is, the devices or the apparatus according to some embodiments may include a memory that stores necessary information of data, a program, and the like, one or more processing circuitry that execute a part or all of the above-described processing, and an interface for communicating with the exterior.

Further, the data inference model according to some embodiments can be used as a program module which is a part of software. That is, the CPU of the computer operates so as to perform computation based on the model stored in the storage part and output the result.

A person skilled in the art may come up with addition, effects or various kinds of modifications of the present disclosure based on the above-described entire description, but examples of the present disclosure are not limited to the above-described individual embodiments. Various kinds of addition, changes and partial deletion can be made within a range that does not depart from the conceptual idea and the gist of the present disclosure derived from the contents stipulated in claims and equivalents thereof.

1. A behavior determining method comprising:
causing, by processing circuitry and first memory, a program to operate on a virtual environment including a virtual memory;
while the program is operating on the virtual environment, generating, by the processing circuitry, access information of the virtual memory for determining a behavior of the program, based on information of at least one of a first flag or a second flag, the first flag indicating whether or not the program has read from a location in a virtual address space, and the second flag indicating whether or not the program has written to the location in the virtual address space; and
inferring, by the processing circuitry, whether the behavior of the program is normal or abnormal based on the access information.

2. The behavior determining method according to claim 1, wherein the generating the access information includes obtaining a state of at least one of the first flag or the second flag on a page-by-page basis, the page being a predetermined unit in the first memory, and generating, as the access information, data containing page-by-page use states of the first memory regarding a predetermined number of pages.

3. The behavior determining method according to claim 1, wherein the generating the access information includes obtaining a state of at least one of the first flag or the second flag every predetermined time, and generating, as the access information, time-series data in a predetermined period.

4. The behavior determining method according to claim 1, further comprising, after the generating the access information, outputting an abnormality degree indicating a degree to which the behavior of the program is abnormal, when the access information is input,
wherein the inferring infers whether the behavior of the program is normal or abnormal based on the abnormality degree of the program.

5. The behavior determining method according to claim 4,
wherein the outputting the abnormality degree of the program includes outputting the abnormality degree of the behavior of the program, based on a behavior discrimination model which, when the access information is input, discriminates whether the behavior of the program is normal or abnormal, and
wherein the inferring includes inferring whether the behavior of the program is normal or abnormal based on the abnormality degree of the program.

6. The behavior determining method according to claim 5, wherein the behavior discrimination model is a classifier which, when the access information is input, outputs a probability with which the behavior of the program belongs to a normal class or a probability with which the behavior of the program belongs to an abnormal class.

7. The behavior determining method according to claim 4,
wherein the outputting the abnormality degree of the program includes outputting the abnormality degree of the program based on a non-identity mapping-access information inference model which, when the access information in a case where the behavior is normal is input, outputs the input access information or outputs a future state of the first memory, and
wherein the inferring infers whether the behavior of the program is normal or abnormal based on the abnormality degree of the program.

8. The behavior determining method according to claim 7,
wherein the access information inference model is a model which is generated by an autoencoder and which, when access information in a case where the program having a normal behavior is executed is input, outputs the input access information, and
wherein the outputting the abnormality degree outputs the abnormality degree based on an error between the access information of the program to be inspected and information which is output when the access information is input to the access information inference model.

9. The behavior determining method according to claim 7,
wherein the access information inference model is a model which is generated so as to, when the access information in a case where the program having a normal behavior is executed is input, output a predetermined-time future state of at least one of the first flag or the second flag, and
wherein the outputting the abnormality degree includes outputting the abnormality degree based on an error between the state of at least one of the first flag or the second flag which state is obtained the predetermined time later after obtaining the access information of the program to be inspected and information which is output when the access information is input to the access information inference model.

10. The behavior determining method according to claim 5, further comprising learning, in advance, the model used in the outputting the abnormality.

11. The behavior determining method according to claim 4, further comprising:
providing an indication when a probability with which the behavior of the program is abnormal is higher than a first threshold value; and
stopping the operation of the program operating on the virtual environment, when the probability with which the behavior of the program is abnormal is higher than a second threshold value having a larger value than the first threshold value.

12. The behavior determining method according to claim 1, wherein, in a case where the processing circuitry is a processor capable of operating the virtual environment on which the program operates and obtaining at least one of the first flag or the second flag while the program is operating, the generating the access information includes generating the access information based on a state of the first memory controlled by the processor.

13. A behavior determining apparatus comprising:
first memory storing data; and
processing circuitry coupled to the first memory, the processing circuitry being configured to:
cause a program to operate on a virtual environment including a virtual memory,
while the program is operating on the virtual environment, generate access information of the virtual memory for determining a behavior of the program, based on information of at least one of a first flag or a second flag, the first flag indicating whether or not the program has read from a location in a virtual address space, and the second flag indicating whether or not the program has written to the location in the virtual address space; and
infer whether the behavior of the program is normal or abnormal based on the access information.

14. The behavior determining apparatus according to claim 13, wherein the processing circuitry is further configured to obtain a state of at least one of the first flag or the second flag on a page-by-page basis, the page being a predetermined unit in the first memory, and generate, as the access information, data containing page-by-page use states of the first memory regarding a predetermined number of pages.

15. The behavior determining apparatus according to claim 13, wherein the processing circuitry is further configured to obtain a state of at least one of the first flag or the second flag every predetermined time, and generate, as the access information, time-series data in a predetermined period.

16. The behavior determining apparatus according to claim 13, wherein the processing circuitry is further configured to:
output, after the generating the access information, an abnormality degree indicating a degree to which the behavior of the program is abnormal, when the access information is input, and
infer whether the behavior of the program is normal or abnormal based on the abnormality degree of the program.

17. A behavior determining system comprising:
first memory storing data; and
processing circuitry coupled to the first memory, the processing circuitry being configured to:
cause a program to operate on a virtual environment including a virtual memory;
generate, while the program is operating on the virtual environment, access information of the virtual memory for determining a behavior of the program, based on information of at least one of a first flag or a second flag, the first flag indicating whether or not the program has read from a location in a virtual address space, and the second flag indicating whether or not the program has written to the location in the virtual address space; and
infer whether the behavior of the program is normal or abnormal based on the access information.

18. The behavior determining system according to claim 17, wherein the processing circuitry is further configured to obtain a state of at least one of the first flag or the second flag on a page-by-page basis, the page being a predetermined unit in the first memory, and generate, as the access information, data containing page-by-page use states of the first memory regarding a predetermined number of pages.

19. The behavior determining system according to claim 17, wherein the processing circuitry is further configured to obtain a state of at least one of the first flag or the second flag every predetermined time, and generate, as the access information, time-series data in a predetermined period.

20. The behavior determining system according to claim 17, wherein the processing circuitry further configured to:
output, after the generating the access information, an abnormality degree indicating a degree to which the behavior of the program is abnormal, when the access information is input,
infer whether the behavior of the program is normal or abnormal based on the abnormality degree of the program.
